(19) United States
(12) Patent Application Publication
(10) Pub. No.: US 2024/0311841 A1
(43) Pub. Date: Sep. 19, 2024

(54) SYSTEMS AND METHODS FOR MULTIMODAL SUPPORT

(71) Applicant: Verizon Patent and Licensing Inc., Basking Ridge, NJ (US)

(72) Inventors: Pradeep Bharthur SHANTHRAJ, Edison, NJ (US); Prasanna Rajagopal, Princeton, NJ (US); Charles J. Forsythe, Morris Plains, NJ (US); Sankar Shanmugam, Dayton, NJ (US); Neil Thomas Razzano, Hillsborough, NJ (US); Rahul Vijaya Rao, Randolph, NJ (US); Ravneet Singh, Cumming, GA (US); Michael Brimshan, Old Bridge Township, NJ (US); Vipul Jha, Plano, TX (US); Lakshmi Ramanathan, Chennai (IN)

(73) Assignee: Verizon Patent and Licensing Inc., Basking Ridge, NJ (US)

(21) Appl. No.: 18/185,125

(22) Filed: Mar. 16, 2023

(51) Int. Cl. G06Q 30/016; G06F 9/451

(52) U.S. Cl. CPC G06Q 30/016; G06F 9/453

(57) ABSTRACT

In some implementations, a system may receive, from a user device, a support request to setup a support session via a first communication modality. The system may determine an intent associated with the support session. The system may provide, to the user device, information to enable a second communication modality for the support session based on the intent associated with the support session. The system may receive, from the user device, an indication of one or more user interactions during the support session via at least one of the first communication modality or the second communication modality. The system may determine an intent associated with the one or more user interactions. The system may provide, to the user device, one or more responses, based on the intent associated with the one or more user interactions, via the first communication modality and the second communication modality.

### BACKGROUND

A virtual agent is a computer program that simulates human interaction to provide assistance, information, and/or services to users. Virtual agents often use artificial intelligence (AI) techniques (e.g., natural language processing (NLP), machine learning, and/or speech recognition techniques, among other examples) to understand user inputs (e.g., provided via user devices of the users) and/or to respond with actions and/or information. For example, virtual agents may answer questions, provide product recommendations, book appointments, and/or resolve customer support issues, among other examples.

### BRIEF DESCRIPTION OF THE DRAWINGS

FIGS. 1A-1C are diagrams of an example associated with multimodal support.

FIGS. 2A-2B are diagrams of an example associated with multimodal support.

FIG. 3 is a diagram of an example environment in which systems and/or methods described herein may be implemented.

FIG. 4 is a diagram of example components of a device associated with multimodal support. FIG. 5 is a flowchart of an example process associated with multimodal support.

### DETAILED DESCRIPTION OF EXAMPLE EMBODIMENTS

The following detailed description of example implementations refers to the accompanying drawings. The same reference numbers in different drawings may identify the same or similar elements.

A virtual agent is a computer program that simulates human interaction to provide assistance, information, and/or services to users. For example, the virtual agent may be used to provide sales and/or marketing services to users, such as engaging with users of a website, answering questions, and/or providing product recommendations (e.g., based on preferences associated with the users). As another example, the virtual agent may be used to provide customer support services to users (e.g., handling queries, providing answers, and/or offering solutions to problems) in various industries (e.g., e-commerce, finance, telecommunications, and/or healthcare industries, among other examples).

In some cases, a support session system may use the virtual agent to provide support to a user (e.g., a customer and/or a subscriber of a mobile network operator (MNO)). To provide the support to the user, the support session system may include a virtual agent, which is sometimes also referred to as a chatbot, that interacts with the user. A virtual agent may be a computer program that is designed to simulate human conversation and/or to provide automated customer service and/or support (e.g., to the user). In general, support session systems typically enable communications (e.g., in a support session) between the virtual agent and the user via a single communication modality, such as a voice communication modality or a text communication modality.

A voice communication modality may enable voice communications between the user and the virtual agent. For example, the user may provide a voice user input (e.g., an audio user input provided by the user by speaking into a microphone component of the user device) to the virtual agent. The virtual agent may receive the voice user input (e.g., via an interface of the virtual agent). The virtual agent may process the voice user input. For example, the virtual agent may convert the spoken words into text (e.g., using a speech recognition technology) and may analyze the text (e.g., using NLP and/or machine learning techniques, among other examples) to understand the voice user input, generate a voice response (e.g., an audio response) associated with the voice user input, and/or perform a task associated with the voice user input. The virtual agent may provide (e.g., via the interface of the virtual agent) the voice response to the user device of the user (e.g., for output via a speaker component of the user device).

A text communication modality may enable text communications between the user and the virtual agent. For example, the user may provide a text user input to the virtual agent. The virtual agent may receive the text user input (e.g., via an interface of the virtual agent). The virtual agent may process the text user input. For example, the virtual agent may analyze the text (e.g., using NLP and/or machine learning techniques, among other examples) to understand the text user input, generate a text response associated with the text user input, and/or perform a task associated with the text user input. The virtual agent may provide (e.g., via the interface of the virtual agent) the text response to the user device of the user (e.g., for display via a user interface of the user device).

However, in some cases, the support session system is unable to provide satisfactory support to the user, for example because the support session system is limited to enabling communications between the virtual agent and the user via the single communication modality. For example, if a text response to a voice user input would be necessary, helpful, or otherwise useful to provide satisfactory support to the user, then the virtual agent cannot provide the text response to the user device because the support session limits the communications between the virtual agent and the user to the voice communication modality. As another example, if a voice response to a text user input would be necessary, helpful, or otherwise useful to provide satisfactory support to a user, then the virtual agent cannot provide the voice response to the user device because the support session limits the communications between the virtual agent and the user to the text communication modality.

Furthermore, when the response is provided via the single communication modality, the virtual agent may generate a response that does not satisfactorily provide support to the user. For example, if the virtual agent provides a complex voice response for output via the speaker component of the user device, then the user may not be able to retain the vast amount of information and/or may not listen to an entirety of the complex voice response. As another example, if the virtual agent provides a complex text response that includes a large number of tasks to be performed by the user for display via the user interface of the user device, then the user may not read an entirety of the complex text response and/or may not be willing to perform the large number of tasks.

The inability to provide satisfactory support via one modality can lead to a user having to escalate the support session (e.g., to communicate with a live agent). In such cases, the resources consumed by the virtual agent are wasted, as the user often has to start from the beginning with the live agent (e.g., explaining the problem and/or information provided by the virtual agent before working with the live agent to address the problem).

Some implementations described herein enable multimodal support (e.g., support communications via at least a first communication modality and a second communication modality). For example, a support session system may receive, from a user device of a user, a support request to setup a support session via a first communication modality (e.g., a voice communication modality, a text communication modality, and/or a visual communication modality, among other examples). The support session system may determine an intent associated with the support session. The support session system may provide, to the user device, information to enable a second communication modality (e.g., a text communication modality if the support session was initially established via a voice communication modality, or a voice communication modality if the support session was initially established via a text communication modality) for the support session based on the intent associated with the support session.

As an example, the support session system may receive, from the user device, an indication of one or more user interactions during the support session via at least one of the first communication modality or the second communication modality. The support session system may determine an intent associated with the one or more user interactions. The support session system may provide, to the user device, one or more responses (e.g., based on the intent associated with the one or more user interactions), via the first communication modality and the second communication modality.

In this way, because the support session system enables communications via at least two communication modalities, the support session system conserves resources (e.g., computing resources, memory resources, and/or network resources, among other examples) that would have been otherwise used determining whether a response is supported by the single communication modality (e.g., the voice communication modality or the text communication modality) that is enabled by the support session system. The support session system also conserves resources by reducing a duration of the support session (e.g., because using at least two communication modalities allows issues associated with the user to be resolved more quickly and efficiently). Additionally, or alternatively, the support session system conserves resources that would have otherwise been used generating a response that does not satisfactorily provide support to the user when the response is provided via the single communication modality (e.g., because the response can be effectively provided to the user via at least two communication modalities).

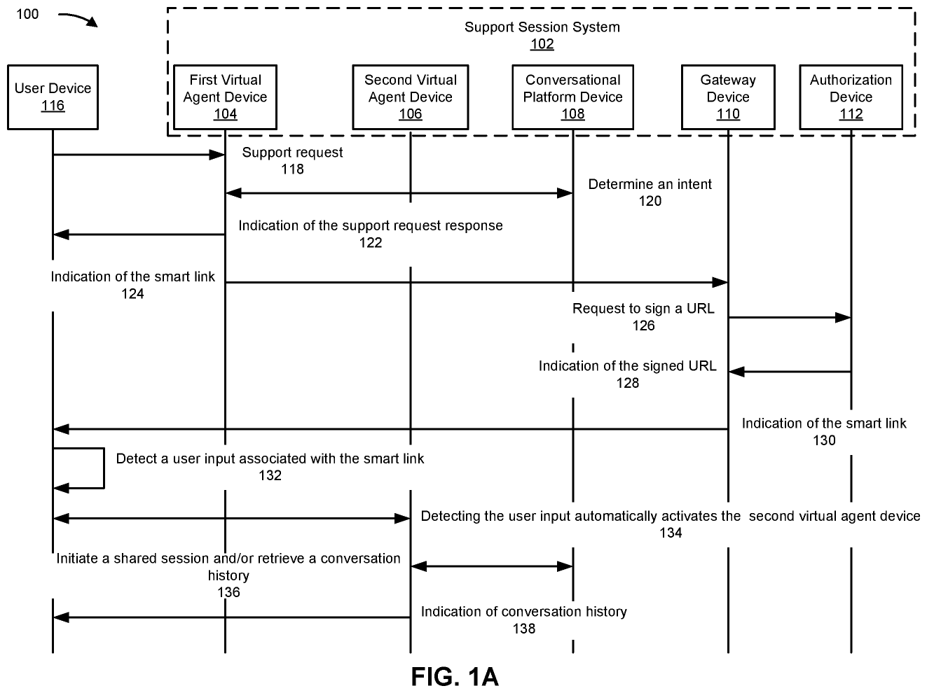

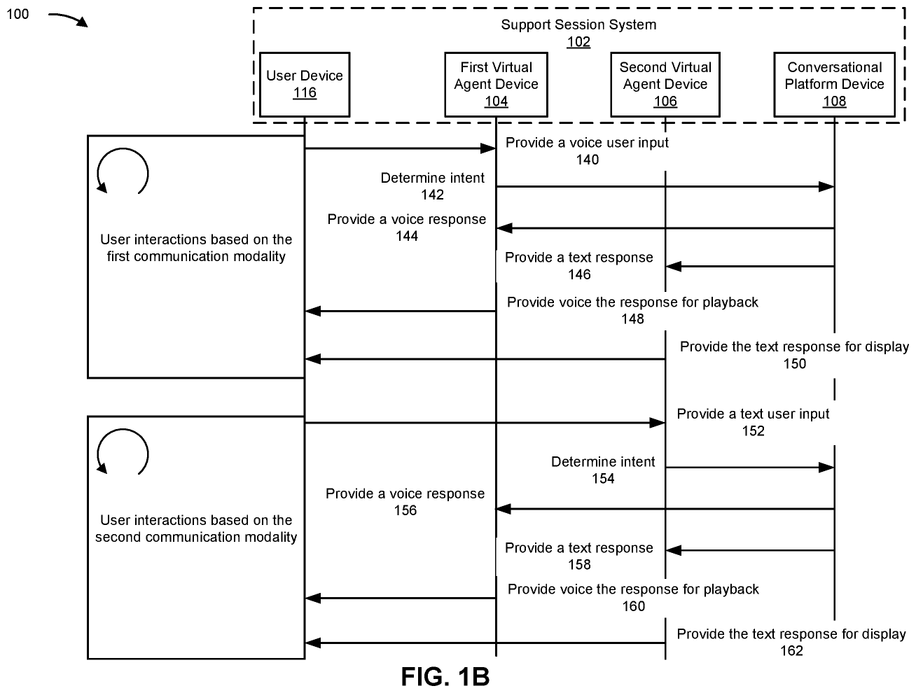

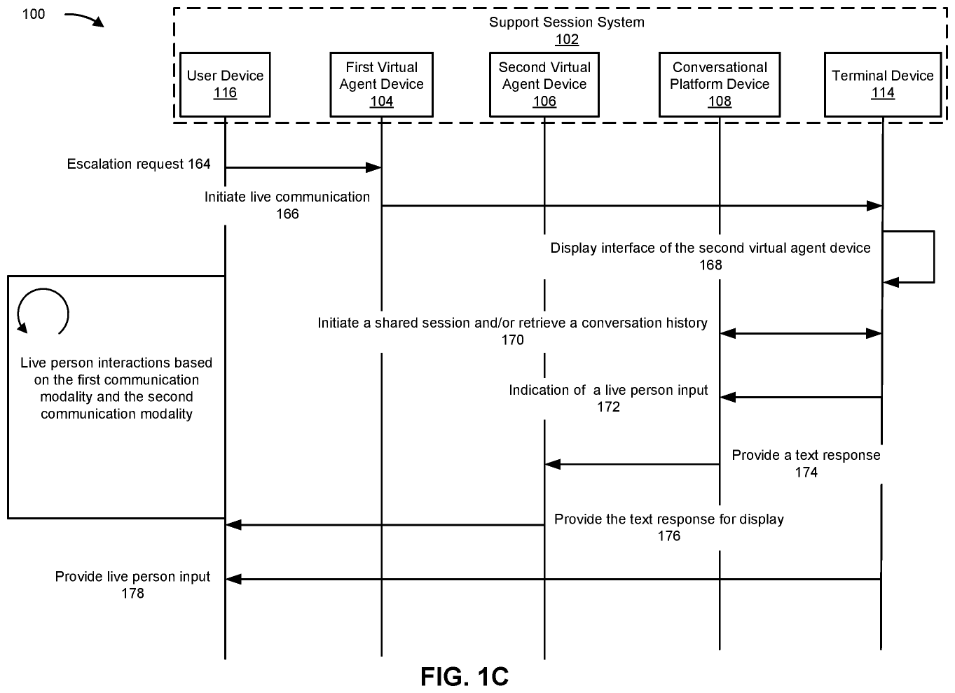

FIGS. 1A-1C are diagrams of an example 100 associated with multimodal support. As shown in FIGS. 1A-1C, example 100 includes a support session system 102. The support session system 102 may include a first virtual agent device 104, a second virtual agent device 106, a conversational platform device 108, a gateway device 110, an authorization device 112, and a terminal device 114. In some implementations, the support session system 102 may be used to establish communication with a user device 116 of a user (e.g., a customer and/or a subscriber of an MNO) to provide the user with support (e.g., during the support session) via multiple communication modalities (e.g., text and voice), as described in more detail elsewhere herein.

As shown in FIG. 1A, and by reference number 118, the first virtual agent device 104 (e.g., executing an interactive voice response (IVR) chatbot) may receive (e.g., via an interface associated with the first virtual agent device 104), from the user device 116, a support request to setup a support session. As an example, the support session system 102 may enable communication between the IVR chatbot executing on the first virtual agent device 104 and a user of the user device 116 via a first communication modality (e.g., a voice communication modality).

As an example, the first virtual agent device 104 may receive (e.g., via the interface of the first virtual agent device 104) the support request as a first input (e.g., a voice input) from the user device 116. For example, the first input may be an utterance of the user that is spoken into a microphone component of the user device 116 (e.g., during a voice call that is established between the first virtual agent device 104 and the user device 116). In some implementations, the support request may include an indication of a request, such as a query, a question, and/or a command provided by the user. The support session system 102 may initiate a support session with the user device 116 (e.g., to provide support to the user) based on the first virtual agent device 104 receiving the support request. For example, in some implementations, the first virtual agent device 104 may provide a voice-based greeting message to the user device 116, which may prompt the user to provide the indication of the request, and the first virtual agent device 104 may then receive the initial request from the user device 116 (e.g., an utterance indicating a reason why the user is requesting support). Furthermore, in some implementations, the first virtual agent device 104 may initiate a session with the conversational platform device 108 to assist with interpreting or otherwise processing utterances received from the user device 104 and generating conversationally-aware voice-based responses to the utterances received from the user device 104 during the support session.

As further shown in FIG. 1A, and by reference number 120, the first virtual agent device 104 may communicate with the conversational platform device 108 to determine an intent (e.g., associated with the support session). In some implementations, the conversational platform device 108 may process the first input to determine the intent associated with the support session. For example, the first virtual agent device 104 may transmit, and the conversational platform device 108 may receive, an indication of the first input. The conversational platform device 108 may analyze (e.g., using speech recognition, NLP and/or machine learning techniques) the first input to determine the intent associated with the support session.

For example, the conversational platform device 108 may convert the first input into text (e.g., using a speech recognition technique). The conversational platform device 108 may analyze the text (e.g., by using NLP and/or machine learning techniques) to determine the intent. As an example, the conversational platform device 108 may classify the first input into one or more intents, such as a support-based intent, a question-based intent, and/or a command-based intent. The support-based intent may be associated with a user request for support. The question-based intent may be associated with a user request for an answer to a question. The command-based intent may be associated with an instruction (e.g., provided by the user) that causes an action to be performed.

For example, if the first input is associated with a query that indicates a request for support, then the conversational platform device 108 may determine that the intent associated with the support request is a support-based intent. As an example, if the first input is associated with a query that indicates a question, then the conversational platform device 108 may determine that the intent associated with the support request is a question-based intent. As another example, if the first input is associated with a query that indicates a command, then the conversational platform device 108 may determine that the intent associated with the support request is a command-based intent.

In some implementations, the conversational platform device 108 may generate a support request response. As an example, the support request response may include an indication of the intent associated with the support session and/or an indication of a voice response (e.g., a voice response) that is generated in response to information indicated via the support request. For example, if the intent is a support-based intent, then the support request response may include an indication of the support-based intent and/or a voice response that indicates information associated with providing support (e.g., based on information that is indicated via the support request).

As an example, if the intent is a question-based intent, then the support request response may include an indication of the question-based intent and/or a voice response that indicates information associated with answering a question (e.g., that is indicated via the support request). As another example, if the intent is a command-based intent, then the support request response may include an indication of the intent and/or a voice response that indicates whether an action has been performed (e.g., based on the information indicated via the support request).

The conversational platform device 108 may transmit, and the first virtual agent device 104 may receive, an indication of the support request response. As shown by reference number 122, the first virtual agent device 104 may transmit (e.g., may forward or otherwise send), and the user device 116 may receive, the indication of the support request response. In some implementations, the first virtual agent device 104 may determine to enable a second communication modality for the support session (e.g., a text communication modality). As an example, the second communication modality may be provided by a second virtual agent executed on the second virtual agent device 106, which may provide an interface for interacting with the second virtual agent via a web-based application and/or an in-application chat interface (e.g., via an application that is installed on the user device 116).

In some implementations the first virtual agent device 104 may generate information to enable a second communication modality for the support session (e.g., based on the intent associated with the support session indicated via the support request response). As an example, the first virtual agent device 104 may generate the information to enable the second communication modality for the support session based on determining that the intent indicated via the support request response is a given type of intent. For example, the first virtual agent device 104 may generate the information to enable the second communication modality for the support session based on determining that the intent indicated in the support request response is a support-based intent that can be serviced via multiple communication modalities. For example, in some implementations, the conversational platform device 108 may support a set of support reasons that can be serviced using a combination of multiple communication modalities (e.g., text and voice), and may provide the user of the user device 116 with an option to enable the second communication modality for the support session based on determining that the intent indicated in the support request response matching one or more of the support reasons that can be serviced using a combination of multiple communication modalities.

In some implementations, the information to enable the second communication modality may be associated with a smart link. A smart link may be a hyperlink that is configured to automatically perform operations (e.g., when a user input indicates that the smart link has been selected by the user). For example, the smart link may be configured to automatically detect a type of application that the second virtual agent device 106 executes on and/or automatically activate an interface of the second virtual agent device 106 for display via the user interface of the user device 116. In some implementations, the first virtual agent device 104 may generate a smart link that has a signed URL. A signed URL may provide access (e.g., temporary access) to a specific resource and/or service (e.g., access to the second virtual agent device 106), and is designed to enhance the security and control of access to that resource and/or service. For example, a signed URL is digitally signed using a private key (e.g., that is known only to an issuer of the URL). As an example, the signature may include an expiration time, after which the URL will no longer be valid.

In some implementations, the first virtual agent device 104 may provide the smart link to the user device 116 via a third communication modality. As an example, the third communication modality may be a short message service (SMS) communication modality, an electronic mail communication modality, an in-application communication modality, and/or a proprietary text message communication modality, among other examples. As shown by reference number 124, the first virtual agent device 104 may transmit, and the gateway device 110 may receive, an indication of the smart link.

As shown by reference number 126, the gateway device 110 may transmit, and the authorization device 112 may receive, a request to sign a URL associated with the smart link. As an example, the authorization device 112 may digitally sign the URL. As shown by reference number 128, the authorization device 112 may transmit, and the gateway device 110 may receive, an indication of the signed URL.

As further shown in FIG. 1A, and by reference number 130, the gateway device 110 may provide, and the user device 116 may receive, an indication of the smart link (e.g., which includes the signed URL). As shown by reference number 132, the user device 116 may detect a user input associated with the smart link. For example, the smart link may be displayed via the user interface of the user device 116. The user device may detect a user input that indicates that the smart link has been selected (e.g., by the user). As shown by reference number 134, detecting the user input (e.g., by the user device 116) automatically activates the second virtual agent device 106. In other words, based on detecting the user input that indicates that the smart link has been selected, the smart link may automatically cause the second virtual agent device 106 to activate and begin to communicate with the user device 116. For example, if the user device 116 includes a web-based interface for interacting with the second virtual agent device 106, then selecting the smart link may cause the second virtual agent device 106 to automatically execute a second virtual agent to communicate with the web-based interface using the second communication modality. As another example, if the user device 116 includes an in-application interface for interacting with the second virtual agent device 106, then the smart link may cause the second virtual agent device 106 to automatically execute the second virtual interface to communicate with the user device 116 via the in-application interface.

As shown by reference number 136, the second virtual agent device 106 may communicate with the conversational platform device 108 to initiate a shared session and/or to retrieve a conversation history. For example, the second virtual agent device 106 may communicate with the conversational platform device 108 based on being activated (e.g., after the smart link is selected). As an example, the conversational platform device 108 may provide, and the second virtual agent device 106 may receive an indication of a conversation history associated with one or more messages that were exchanged between the user device 116 and the first virtual agent device 104 prior to activation of the second communication modality. In other words, the conversational platform device 108 may provide the second virtual agent device 106 with a context associated with the communications between the user device 116 and the first virtual agent device 104 that have been exchanged during the support session.

As further shown in FIG. 1A, and by reference number 138, the second virtual agent device 106 may provide, and the user device 116 may receive, the indication of the conversation history associated with the support session. As an example, the conversation history associated with the support session may be displayed via the user interface of the user device 116. In this way, the communications exchanged between the user device 116 and the first virtual agent device 104 via the first communication modality prior to activation of the second communication modality may be displayed on the user device 116, and the user may then provide a user input (e.g., via the user device 116) to continue the conversation using the first communication modality and/or the second communication modality. For example, the support session system 102 may receive, from the user device 116, an indication of one or more user interactions (e.g., an indication of a voice user input and/or a text user input) during the support session via at least one of the first communication modality or the second communication modality, as described in more detail elsewhere herein.

As shown in FIG. 1B, and by reference number 140, the first virtual agent device 104 may receive, and the user device 116 may provide, a voice user input. For example, the voice user input may be one or more utterances of the user that are spoken into a microphone component of the user device 116 (e.g., during a voice call associated with the support session). In some implementations, the voice user input may include an indication of a query, such as the query described in connection with reference number 118 of FIG. 1A and/or as described in more detail elsewhere herein.

As shown by reference number 142, the first virtual agent device 104 may communicate with the conversational platform device 108 to determine an intent associated with the voice user input. In some implementations, the conversational platform device 108 may process the voice user input to determine the intent associated with the voice user input in a similar manner as determining the intent associated with the support session as described above in connection with reference number 120 of FIG. 1A and/or as described in more detail elsewhere herein.

As shown by reference number 144, the conversational platform device 108 may provide a voice response (e.g., based on determining the intent associated with the voice user input). In some implementations, the conversational platform device 108 may generate the voice response based on determining the intent associated with the voice user input. As an example, the response may include an indication of the intent associated with the voice user input and/or a voice response that is generated in response to information indicated via the voice user input. As an example, the conversational platform device 108 may provide an indication of the voice response to the first virtual agent device 104.

As shown by reference number 146, the conversational platform device 108 may provide a text response (e.g., based on determining the intent associated with the voice user input). In some implementations, the conversational platform device 108 may generate the text response based on determining the intent associated with the voice user input. As an example, the response may include an indication of the intent associated with the voice user input and/or a text response that is generated in response to information indicated via the voice user input. As an example, the conversational platform device 108 may provide an indication of the text response to the second virtual agent device 106.

As shown by reference number 148, the first virtual agent device 104 may provide, and the user device 116 may receive, the voice response for playback (e.g., via the speaker component of the user device 116). For example, the first virtual agent device 104 may transmit (e.g., may forward), and the user device 116 may receive, the indication of the voice response. The voice response may be output via the speaker component of the user device 116.

As shown by reference number 150, the second virtual agent device 106 may provide, and the user device 116 may receive, the text response for display (e.g., via the user interface of the user device 116). For example, the second virtual agent device 106 may transmit (e.g., may forward), and the user device 116 may receive, the indication of the text response. The text response may be displayed via the user interface of the user device 116.

As shown by reference number 152, the second virtual agent device 106 may receive, and the user device 116 may provide, a text user input. As an example, the second virtual agent device 106 may receive (e.g., via the interface of the second virtual agent device 106) the text user input. For example, the text user input may be words that are typed into the user interface of the user device 116. In some implementations, the text user input may include an indication of a query, such as the query described in connection with reference number 118 of FIG. 1A and/or as described in more detail elsewhere herein.

As shown by reference number 154, the second virtual agent device 106 may communicate with the conversational platform device 108 to determine an intent (e.g., associated with the text user input). In some implementations, the conversational platform device 108 may process the text user input to determine the intent associated with the voice user input in a similar manner as determining the intent associated with the support session as described above in connection with reference number 120 of FIG. 1A and/or as described in more detail elsewhere herein.

As shown by reference number 156, the conversational platform device 108 may provide a voice response (e.g., based on determining the intent associated with the text user input). In some implementations, the conversational platform device 108 may generate the voice response based on determining the intent associated with the text user input. As an example, the response may include an indication of the intent associated with the text user input and/or a voice response that is generated in response to information indicated via the text user input. As an example, the conversational platform device 108 may provide an indication of the voice response to the first virtual agent device 104.

As shown by reference number 158, the conversational platform device 108 may provide a text response (e.g., based on determining the intent associated with the text user input). In some implementations, the conversational platform device 108 may generate the text response based on determining the intent associated with the text user input. As an example, the response may include an indication of the intent associated with the text user input and/or a text response that is generated in response to information indicated via the text user input. As an example, the conversational platform device 108 may provide an indication of the text response to the second virtual agent device 106.

As shown by reference number 160, the first virtual agent device 104 may provide, and the user device 116 may receive, the voice response for playback (e.g., via the speaker component of the user device 116). For example, the first virtual agent device 104 may transmit (e.g., may forward), and the user device 116 may receive, the indication of the voice response. The voice response may be output via the speaker component of the user device 116.

As shown by reference number 162, the second virtual agent device 106 may provide, and the user device 116 may receive, the text response for display (e.g., via the user interface of the user device 116). For example, the second virtual agent device 106 may transmit (e.g., may forward), and the user device 116 may receive, the indication of the text response. The text response may be displayed via the user interface of the user device 116.

As shown in FIG. 1C, and by reference number 164, the first virtual agent device 104 may receive, and the user device 116 may provide, an escalation request. For example, the escalation request may indicate a request to communicate with a live person (e.g., a live agent) during the support session.

As shown by reference number 166, the first virtual agent device 104 may initiate live communication (e.g., between the terminal device 114 operated by the live person and the user device 116 of the user). As shown by reference number 168, the terminal device 114 may display the interface of the second virtual agent device 106 (e.g., the text-based interface). In this way, the terminal device 114 may display the text-based conversation history associated with the support session to the live person to assist the live person with providing support to the user.

As shown by reference number 170, the terminal device 114 may communicate with the conversational platform device 108 to initiate a shared session and/or to retrieve a conversation history. As an example, the conversational platform device 108 may provide, and the terminal device 114 may receive an indication of a conversation history associated with one or more messages conveyed exchanged between the user device 116, the first virtual agent device 104 and the second virtual agent device 106. In other words, the conversational platform device 108 may provide the terminal device 114 ith a textual context associated with the communications between the user device 116, the first virtual agent device 104, and the second virtual agent device 106 that have been exchanged during the support session.

As shown by reference number 172, the terminal device 114 may provide, and the conversational platform device 108 may receive, an indication of a live person input received from the live person operating the terminal device 114. For example, the live person input may be a live voice response provided by the live person into a microphone component of the terminal device 114. As an example, the conversational platform device 108 may convert the live voice response to a text response (e.g., by using a speech recognition technique).

As shown by reference number 174, the conversational platform device 108 may provide the text response to the second virtual agent device 106. As shown by reference number 176, the second virtual agent device 106 may provide, and the user device 116 may receive, the text response for display (e.g., via the user interface of the user device 116). For example, the second virtual agent device 106 may transmit (e.g., may forward), and the user device 116 may receive, the indication of the text response. The text response may be displayed via the user interface of the user device 116.

As shown by reference number 178, the terminal device 114 may provide, and the user device 116 may receive, an indication of the live person input. For example, the user device 116 may output the live voice response via the speaker component of the user device 116. In this way, the text response and the live voice response may be communicated to the user at approximately the same time.

In some implementations, the live person may continue to communicate with the user of the user device 116 (e.g., via communications between the terminal device 114 and the user device 116) after the escalation request. For example, the live person may communicate with the user via the first communication modality and the second communication modality to provide support to the user during the support session.

In this way, because the support session system enables communications via at least two communication modalities, the support session system conserves resources (e.g., computing resources, memory resources, and/or network resources, among other examples) that would have been otherwise used determining whether a response is supported by the single communication modality (e.g., the voice communication modality or the text communication modality) that is enabled by the support session system. The support session system also conserves resources by reducing a duration of the support session (e.g., because using at least two communication modalities allows issues associated with the user to be resolved more quickly and efficiently). Additionally, or alternatively, the support session system conserves resources that would have otherwise been used generating a response that does not satisfactorily provide support to the user when the response is provided via the single communication modality (e.g., because the response can be effectively provided to the user via at least two communication modalities).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

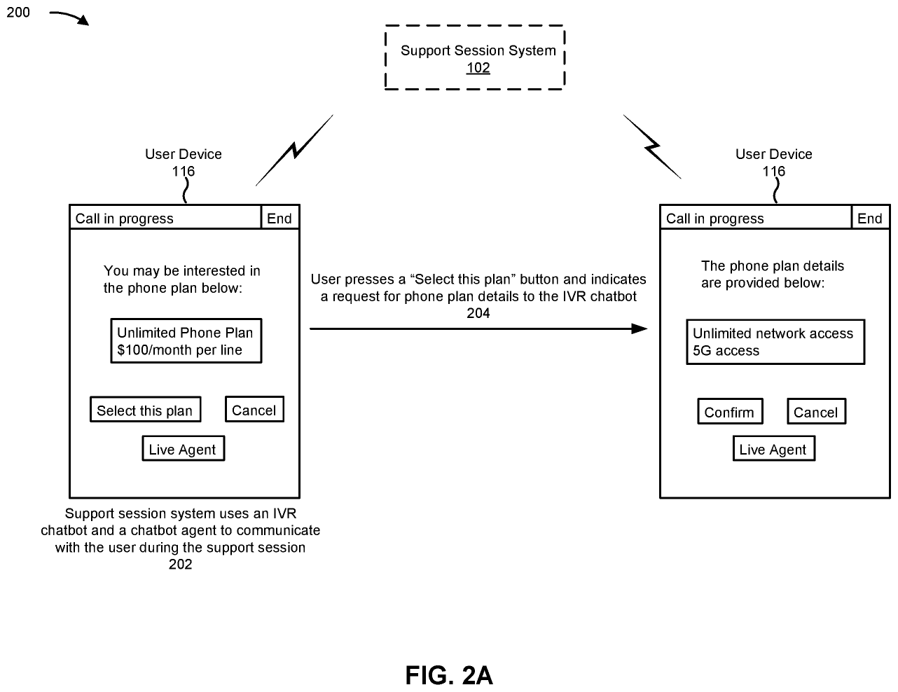

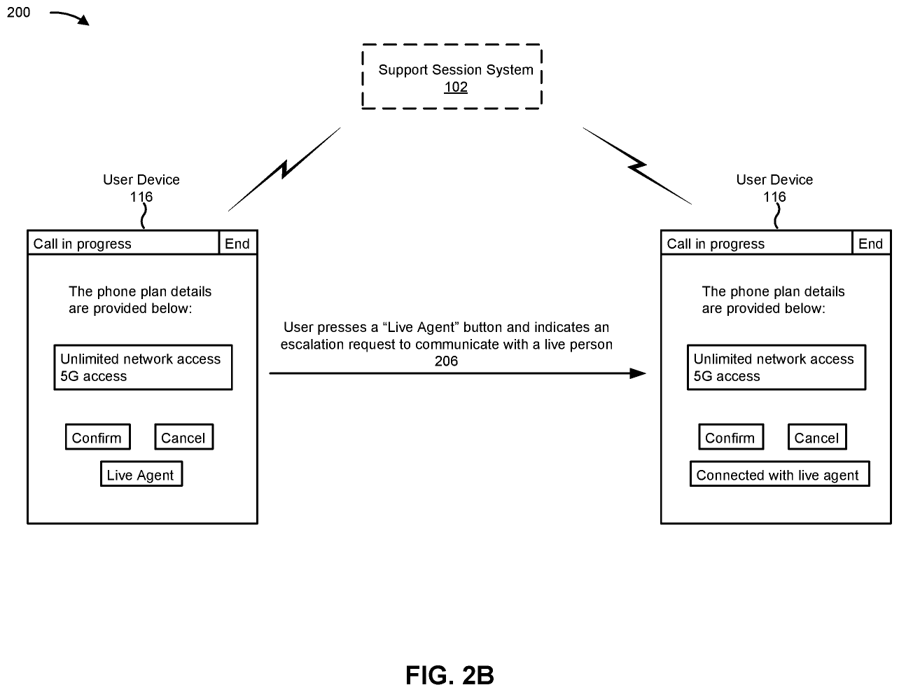

FIGS. 2A-2B are diagrams of an example 200 associated with multimodal support. As shown in FIGS. 2A-2B, example 200 includes a support session system 102 and a user device 116. In example 200, the support session system 102 uses an IVR chatbot (e.g., an IVR chatbot that executes on the first virtual agent device 104, as described in more detail elsewhere herein), a chatbot agent (e.g., a virtual chat agent that executes on the second virtual agent device 106, as described in more detail elsewhere herein), and a live agent (e.g., a live person using the terminal device 114, as described in more detail elsewhere herein) to provide support to a user during a support session. Furthermore, in example 200, the IVR chatbot communicates with the user via voice communications (e.g., audio responses), the chatbot agent communicates with the user via text communications (e.g., via an in-application chat interface), and the live agent communicates with the user via voice communications (e.g., live person voice communications).

As shown in FIG. 2A, and by reference number 202, the support session system 102 uses the IVR chatbot and the agent to communicate with the user during the support session. As an example, in the support session, the chatbot agent provides a text indication of a phone plan recommendation to the user (e.g., shown as the text of “you may be interested in the phone plan below” and the text of “unlimited phone plan $100/month per line” provided via the in-application interface in FIG. 2A). Although the chatbot agent has been described as providing the phone plan recommendation to the user, the IVR chatbot may also provide an audio indication of the phone plan recommendation to the user. As an example, the IVR chatbot and/or the chatbot agent may provide the phone plan recommendation in response to a request for phone plan recommendations from the user to the IVR chatbot and/or the chatbot agent.

As shown by reference number 204, the user presses a “select this plan” button and indicates a request for phone plan details to the IVR chatbot. As an example, the chatbot agent provides a text indication of the phone plan details to the user (e.g., shown as the text of “the phone plan details are provided below,” the text of “unlimited network access,” and the text of “5G access” provided via the in-application interface in FIG. 2A) in response to the user pressing the “select this plan” button and indicating the request for phone plan details. Although the phone plan details have been described as being provided by the chatbot agent, the IVR chatbot may also provide an audio indication of the phone plan details to the user.

As shown in FIG. 2B, and by reference number 206, the user presses a “live agent” button and indicates an escalation request to communicate with a live person (e.g., during the support session). Based on the user pressing the “live agent” button and indicating the escalation request, the IVR chatbot and/or the chatbot agent may enable the user to communicate with the live person (e.g., via the terminal device 114, as described in more detail elsewhere herein). For example, if the user is not satisfied with the support provided by the IVR chatbot and/or the chatbot agent during the support session, then the user may indicate the escalation request to receive satisfactory support from a live person (e.g., the live agent).

In this way, the support session system 102 may interact with the user via multiple communication modalities to provide support to the user during the support session. For example, the support session system 102 may provide information and/or services to the user via multiple communication modalities (e.g., audio responses, text responses, and/or visual responses, among other examples) and/or may receive information from the user via multiple communication modalities (e.g., audio user inputs, text user inputs, and/or user interactions via an interface, among other examples) to provide support to the user during the support session.

As indicated above, FIGS. 2A-2B are provided as an example. Other examples may differ from what is described with regard to FIGS. 2A-2B. The number and arrangement of devices shown in FIGS. 2A-2B are provided as an example. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

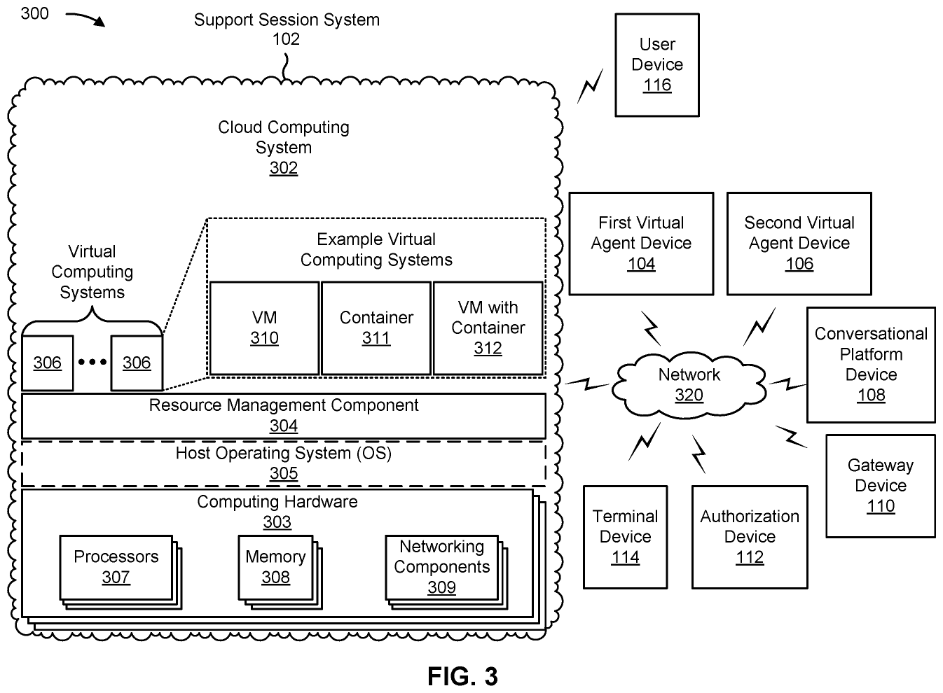

FIG. 3 is a diagram of an example environment 300 in which systems and/or methods described herein may be implemented. As shown in FIG. 3, environment 300 may include a support session system 102 which may include one or more elements of and/or may execute within a cloud computing system 302. The cloud computing system 302 may include one or more elements 303-312, as described in more detail below. As further shown in FIG. 3, environment 300 may include a network 320, a first virtual agent device 104, a second virtual agent device 106, a conversational platform device 108, a gateway device 110, an authorization device 112, and/or a terminal device 114. The support session system 102 may be used to communicate with the user device 116. Devices and/or elements of environment 300 may interconnect via wired connections and/or wireless connections.

The first virtual agent device 104 may include one or more devices capable of receiving, generating, storing, processing, providing, and/or routing information associated with multimodal support, as described elsewhere herein. The first virtual agent device 104 may include a communication device and/or a computing device. For example, the first virtual agent device 104 may include a server, such as an application server, a client server, a web server, a database server, a host server, a proxy server, a virtual server (e.g., executing on computing hardware), or a server in a cloud computing system. In some implementations, the first virtual agent device 104 may include computing hardware used in a cloud computing environment (e.g., the cloud computing system 302 associated with the support session system 102).

The second virtual agent device 106 may include one or more devices capable of receiving, generating, storing, processing, providing, and/or routing information associated with multimodal support, as described elsewhere herein. The second virtual agent device 106 may include a communication device and/or a computing device. For example, the second virtual agent device 106 may include a server, such as an application server, a client server, a web server, a database server, a host server, a proxy server, a virtual server (e.g., executing on computing hardware), or a server in a cloud computing system. In some implementations, the second virtual agent device 106 may include computing hardware used in a cloud computing environment (e.g., the cloud computing system 302 associated with the support session system 102).

The conversational platform device 108 may include one or more devices capable of receiving, generating, storing, processing, providing, and/or routing information associated with multimodal support, as described elsewhere herein. The conversational platform device 108 may include a communication device and/or a computing device. For example, the conversational platform device 108 may include a server, such as an application server, a client server, a web server, a database server, a host server, a proxy server, a virtual server (e.g., executing on computing hardware), or a server in a cloud computing system. In some implementations, the conversational platform device 108 may include computing hardware used in a cloud computing environment (e.g., the cloud computing system 302 associated with the support session system 102).

The gateway device 110 may include one or more devices capable of receiving, generating, storing, processing, providing, and/or routing information associated with multimodal support, as described elsewhere herein. The gateway device 110 may include a communication device and/or a computing device. For example, the gateway device 110 may include a server, such as an application server, a client server, a web server, a database server, a host server, a proxy server, a virtual server (e.g., executing on computing hardware), or a server in a cloud computing system. In some implementations, the gateway device 110 may include computing hardware used in a cloud computing environment (e.g., the cloud computing system 302 associated with the support session system 102).

The authorization device 112 may include one or more devices capable of receiving, generating, storing, processing, providing, and/or routing information associated with multimodal support, as described elsewhere herein. The authorization device 112 may include a communication device and/or a computing device. For example, the authorization device 112 may include a server, such as an application server, a client server, a web server, a database server, a host server, a proxy server, a virtual server (e.g., executing on computing hardware), or a server in a cloud computing system. In some implementations, the authorization device 112 may include computing hardware used in a cloud computing environment (e.g., the cloud computing system 302 associated with the support session system 102).

The terminal device 114 may include one or more devices capable of receiving, generating, storing, processing, and/or providing information associated with multimodal support, as described elsewhere herein. The terminal device 114 may include a communication device and/or a computing device. For example, the terminal device 114 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device (e.g., the cloud computing system 302 associated with the support session system 102).

The user device 116 may include one or more devices capable of receiving, generating, storing, processing, and/or providing information associated with multimodal support, as described elsewhere herein. The user device 116 may include a communication device and/or a computing device. For example, the user device 116 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

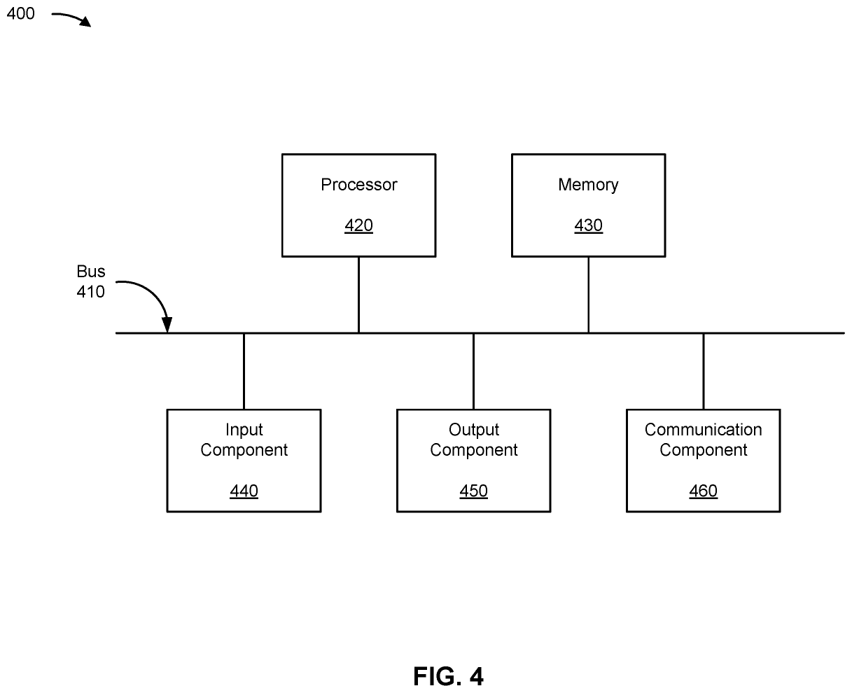

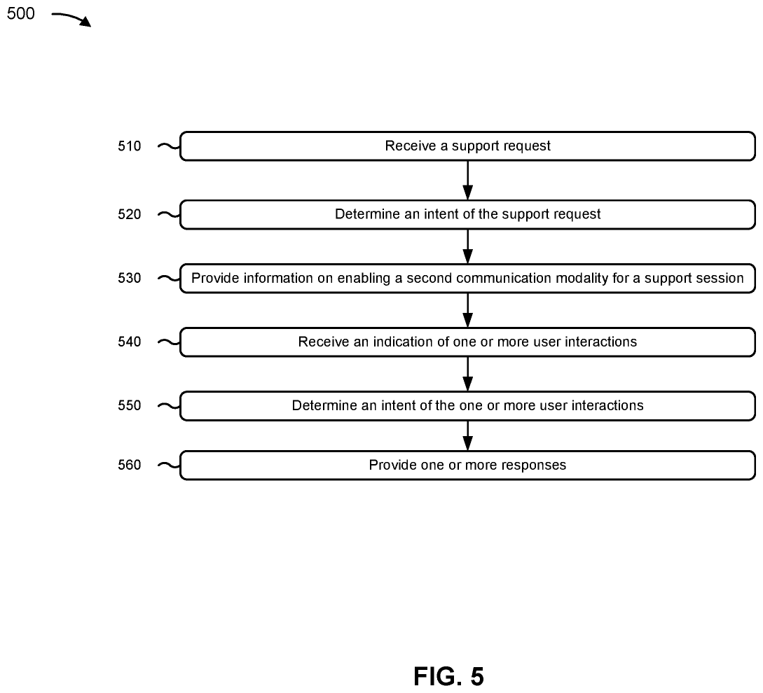

Although the support session 201 may include one or more elements 303-312 of the cloud computing system 302, may execute within the cloud computing system 302, and/or may be hosted within the cloud computing system 302, in some implementations, the support session 201 may not be cloud-based (e.g., may be implemented outside of a cloud computing system) or may be partially cloud-based. For example, the support session 201 may include one or more devices that are not part of the cloud computing system 302, such as device 400 of FIG. 4, which may include a standalone server or another type of computing device. The support session 201 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with multimodal support. The device 400 may correspond to the user device 116, the first virtual agent device 104, the second virtual agent device 106, the conversational platform device 108, the gateway device 110, the authorization device 112, and/or the terminal device 114. In some implementations, the user device 116, the first virtual agent device 104, the second virtual agent device 106, the conversational platform device 108, the gateway device 110, the authorization device 112, and/or the terminal device 114 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

FIG. 5 is a flowchart of an example process 500 associated with multimodal support. In some implementations, one or more process blocks of FIG. 5 may be performed by a support session system (e.g., the support session system 102). In some implementations, one or more process blocks of FIG. 5 may be performed by another device or a group of devices separate from or including the support session system, such as a first virtual agent device (e.g., the first virtual agent device 104), a second virtual agent device (e.g., the second virtual agent device 106), a conversational platform device (e.g., the conversational platform device 108), a gateway device (e.g., the gateway device 110), an authorization device (e.g., the authorization device 112), and/or a terminal device (e.g., the terminal device 114). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, from a user device, a support request to setup a support session via a first communication modality (block 510). For example, the support session system may receive, from a user device, a support request to setup a support session via a first communication modality, as described above.

As shown in FIG. 5, process 500 may include determining an intent associated with the support session (block 520). For example, the support session system may determine an intent associated with the support session, as described above.

As further shown in FIG. 5, process 500 may include providing, to the user device, information to enable a second communication modality for the support session based on the intent associated with the support session (block 530). For example, the support session system may provide, to the user device, information to enable a second communication modality for the support session based on the intent associated with the support session, as described above. In some implementations, providing the information to enable the second communication modality associated with the support session based on the intent associated with the support session comprises providing, to the user device, the second communication modality via a third communication modality. In some implementations, the second communication modality is at least one of an in-application communication modality, or a web-based communication modality. In some implementations, the first communication modality is a voice-based communication modality, and wherein the second communication modality is a text-based communication modality.

In some implementations, process 500 includes providing, via the second communication modality, information that provides a context associated with one or more messages conveyed to the user device during the support session via the first communication modality.

As further shown in FIG. 5, process 500 may include receiving, from the user device, an indication of one or more user interactions during the support session via at least one of the first communication modality or the second communication modality (block 540). For example, the support session system may receive, from the user device, an indication of one or more user interactions during the support session via at least one of the first communication modality or the second communication modality, as described above.

In some implementations, receiving the indication of the one or more user interactions comprises receiving a first user interaction via the first communication modality, and receiving a second user interaction via the second communication modality, wherein the intent associated with the one or more user interactions and the one or more responses provided to the user device are based on the first user interaction and the second user interaction.

As further shown in FIG. 5, process 500 may include determining an intent associated with the one or more user interactions (block 550). For example, the support session system may determine an intent associated with the one or more user interactions, as described above.

As further shown in FIG. 5, process 500 may include providing, to the user device, one

or more responses, based on the intent associated with the one or more user interactions, via the first communication modality, and the second communication modality (block 560). For example, the support session system may provide, to the user device, one or more responses, based on the intent associated with the one or more user interactions, via the first communication modality, and the second communication modality, as described above.

In some implementations, process 500 includes receiving, from the user device, an escalation request to communicate with a live person during the support session, and enabling, based on the escalation request, communication between the user device and a terminal device associated with the live person via at least one of the first communication modality, or the second communication modality.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a support session system and from a user device, a support request to setup a support session via a first communication modality,
determining, by the support session system, an intent associated with the support session;
providing, by the support session system and to the user device, information to enable a second communication modality for the support session based on the intent associated with the support session;
receiving, by the support session system and from the user device, an indication of one or more user interactions during the support session via at least one of the first communication modality or the second communication modality;
determining, by the support session system, an intent associated with the one or more user interactions; and
providing, by the support session system and to the user device, one or more responses, based on the intent associated with the one or more user interactions, via the first communication modality, and the second communication modality.

2. The method of claim 1, wherein providing the information to enable the second communication modality associated with the support session based on the intent associated with the support session comprises:
providing, to the user device, the second communication modality via a third communication modality.

3. The method of claim 1, wherein the second communication modality is at least one of:
an in-application communication modality, or
a web-based communication modality.

4. The method of claim 1, further comprising:
providing, via the second communication modality, information that provides a context associated with one or more messages conveyed to the user device during the support session via the first communication modality.

5. The method of claim 1, further comprising:
receiving, from the user device, an escalation request to communicate with a live person during the support session; and
enabling, based on the escalation request, communication between the user device and a terminal device associated with the live person via at least one of:
the first communication modality, or
the second communication modality.

6. The method of claim 1, wherein the first communication modality is a voice-based communication modality, and
wherein the second communication modality is a text-based communication modality.

7. The method of claim 1, wherein receiving the indication of the one or more user interactions comprises:
receiving a first user interaction via the first communication modality; and
receiving a second user interaction via the second communication modality,
wherein the intent associated with the one or more user interactions and the one or more responses provided to the user device are based on the first user interaction and the second user interaction.

8. A support session system, comprising:
one or more processors configured to:
receive, from a user device, a support request to setup a support session via a first communication modality,
determine an intent associated with the support session;
provide, to the user device, information to enable a second communication modality for the support session based on the intent associated with the support session;
receive, from the user device, an indication of one or more user interactions during the support session via at least one of the first communication modality or the second communication modality;
determine an intent associated with the one or more user interactions; and
provide, to the user device, one or more responses, based on the intent associated with the one or more user interactions, via the first communication modality, and the second communication modality.

9. The support session system of claim 8, wherein the one or more processors, to provide the information to enable the second communication modality for the support session based on the intent associated with the support session, are configured to:
provide, to the user device, the second communication modality via a third communication modality.

10. The support session system of claim 8, wherein the second communication modality is at least one of:
an in-application communication modality, or
a web-based communication modality.

11. The support session system of claim 8, wherein the one or mor processors are further configured to:
provide, via the second communication modality, information that provides a context associated with one or more messages conveyed to the user device during the support session via the first communication modality.

12. The support session system of claim 8, wherein the one or more processors are further configured to:
receive, from the user device, an escalation request to communicate with a live person during the support session; and
enable, based on the escalation request, communication between the user device and a terminal device associated with the live person via at least one of:
the first communication modality, or
the second communication modality.

13. The support session system of claim 8, wherein the first communication modality is a voice-based communication modality, and
wherein the second communication modality is a text-based communication modality.

14. The support session system of claim 8, wherein the one or more processors, to receive the indication of the one or more user interactions during the support session via at least one of the first communication modality or the second communication modality, are configured to:
receive a first user interaction via the first communication modality; and
receive a second user interaction via the second communication modality,
wherein the intent associated with the one or more user interactions and the one or more responses provided to the user device are based on the first user interaction and the second user interaction.

15. A non-transitory computer-readable medium storing a set of instructions, the set of instructions comprising:
one or more instructions that, when executed by one or more processors of a support session system, cause the support session system to:
receive, from a user device, a support request to setup a support session via a first communication modality,
determine an intent associated with the support session;
provide, to the user device, information to enable a second communication modality for the support session based on the intent associated with the support session;
receive, from the user device, an indication of one or more user interactions during the support session via at least one of the first communication modality or the second communication modality;
determine an intent associated with the one or more user interactions; and
provide, to the user device, one or more responses, based on the intent associated with the one or more user interactions, via the first communication modality, and the second communication modality.

16. The non-transitory computer-readable medium of claim 15, wherein the one or more instructions, that cause the support session system to provide the information to enable the second communication modality for the support session based on the intent associated with the support session, cause the support session system to:
provide, to the user device, the second communication modality via a third communication modality.

17. The non-transitory computer-readable medium of claim 15, wherein the second communication modality is at least one of:
an in-application communication modality, or
a web-based communication modality.

18. The non-transitory computer-readable medium of claim 15, wherein the one or more instructions, when executed by the one or more processors, further cause the support session system to:
provide, via the second communication modality, information that provides a context associated with one or more messages conveyed to the user device during the support session via the first communication modality.

19. The non-transitory computer-readable medium of claim 15, wherein the one or more instructions, when executed by the one or more processors, further cause the support session system to:
receive, from the user device, an escalation request to communicate with a live person during the support session; and
enable, based on the escalation request, communication between the user device and a terminal device associated with the live person via at least one of:
the first communication modality, or
the second communication modality.

20. The non-transitory computer-readable medium of claim 15, wherein the first communication modality is a voice-based communication modality, and
wherein the second communication modality is a text-based communication modality.
